(19) United States
(12) Patent Application Publication
(10) Pub. No.: US 2008/0009558 A1
(43) Pub. Date: Jan. 10, 2008

(54) ONE-STEP MICROWAVE PREPARATION OF WELL-DEFINED AND FUNCTIONALIZED POLYMERIC NANOPARTICLES

(75) Inventors: Craig Hawker, Santa Barbara, CA (US); Galen Stucky, Santa Barbara, CA (US); Zesheng An, Goleta, CA (US)

Correspondence Address: JOHN P. O'BANION;O'BANION & RITCHEY LLP, 400 CAPITOL MALL SUITE 1550, SACRAMENTO, CA, 95814, US

(73) Assignee: THE REGENTS OF THE UNIVERSITY OF CALIFORNIA, Oakland, CA (US)

(21) Appl. No.: 11/677,860

(22) Filed: Feb. 22, 2007

Related U.S. Application Data
(60) Provisional application No. 60/806,920, filed on Jul. 10, 2006.
(60) Provisional application No. 60/806,922, filed on Jul. 10, 2006.

(51) Int. Cl. C08F 2/46

(52) U.S. Cl. 522/57

(57) ABSTRACT

Disclosed is a microwave preparation method for producing polymeric nanoparticles in which a mixture is made that contains a monomer, an optional functionalize co-monomer, a polymerization initiator that is activated by microwave irradiation, a cross-linker that preferentially creates intra-particle cross-links during polymerization, and a water-based solvent which is then irradiated with microwave radiation to facilitate polymerization of the nanoparticles into sub-50 nm size range nanoparticles.

### CROSS-REFERENCE TO RELATED APPLICATIONS

This application claims priority from U.S. provisional application Ser. No. 60/806,920, filed on Jul. 10, 2006, incorporated herein by reference in its entirety, and from U.S. provisional application Ser. No. 60/806,922, filed on Jul. 10, 2006, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to well-defined colloidal polymeric nanoparticles produced utilizing a microwave methodology that generates narrowly dispersed, intra-cross-linked polymeric nanoparticles, with derivatized surfaces, if desired, at high solids content through a surfactant-free emulsion polymerization process. The nanoparticle size is controlled by using intra-crosslinkers with enhanced reactivity through a one-step microwaving process. The successful size control is realized by confining the generated cross-linking to intra-particle cross-linking rather than inter-particle cross-linking. Additionally, the superheating/dielectric heating effect associated with microwave irradiation is utilized to effectively reduce the nanoparticle size. More particularly, the subject invention discloses polymeric nanoparticles and a method of production of the nanoparticles utilizing a method comprising microwave irradiation of a solution comprised of monomers, an initiator, a cross-linking agent, a hydrophilic solvent, and, optionally, functional group-containing co-monomers.

2. Description of Related Art

Emulsion polymerization is an important industrial process for production of colloidal polymers. Polymeric nanoparticles (NPs) represent an important class of materials that are critical in a wealth of advanced technologies, ranging from colloidal crystals (de Villeneuve, V. W. A.; Dullens, R. P. A.; Aarts, D. G. A. L.; Groeneveld, E.; Scherff, J. H.; Kegel, W. K.; Lekkerkerker, H. N. W. Science 2005, 309, 1231-1233), microelectronics (Magbitang, T.; Lee, V. Y.; Miller, R. D.; Toney, M. F.; Lin, Z.; Briber, R. M.; Kim, H.-C.; Hedrick, J. L. Adv. Mater. 2005, 17, 1031-1035), drug delivery (Ha, C.-S.; Jr. Gardella, J. A. Chem. Rev. 2005, 105, 4205-4232) to immunoassays (Montagne, P.; el-Omari, R.; Cliquet, T.; Cuilliere, M. L.; Dujeile, J. Bioconj. Chem. 1992, 3, 504-509). Among various synthetic strategies for NP preparation (e.g. self-assembly of amphiphilic block copolymers (Harrisson, S.; Wooley, K. L. Chem. Commun. 2005, 26, 3259-3261 and Hawker, C. J.; Wooley, K. L. Science 2005, 309, 1200-1204) and colloidal particles by emulsion polymerization (Wang, Q.; Fu, S.; Yu, T. Prog. Polym. Sci. 1994, 19, 703-753; Elaissari, A. E., Ed. Colloidal Polymers, M-Dekker: New York, 2003; and Jang, J.; Oh, J. H.; Stucky, G. D. Angew. Chem. Int. Ed. 2002, 41, 4016-4019)), surfactant-free emulsion polymerization (SFEP) has emerged as a simple, green process for NP production without addition and subsequent removal of the stabilizing surfactants (Zhang, G.; Li, X.; Jiang, M.; Wu, C. Langmuir 2000, 16, 9205-9207; Mouaziz, H.; Larsson, A.; Sherrington, D. C. Macromolecules 2004, 37, 1319-1323; and Shim, S. E.; Shin, Y.; Jun, J. W.; Lee, K.; Jung, H.; Choe, S. Macromolecules 2003, 36, 7994-8000). It is noted that the traditional emulsion processes typically use a lot of surfactants to enhance colloidal stability of the polymer particles and to reduce the particle size. Unfortunately, the addition of surfactants can change the properties of the polymer particles, especially the surface properties of the polymers. Additionally, removal of the surfactants is a time consuming and costly process. An added value for colloidal polymerization is that the produced polymers are confined in colloidal particles with defined size, which provides opportunities for applications of the polymers in the scale of micrometer and even nanometer ranges. In addition to several additional novel aspects, surfactant-free conditions are utilized in the subject invention in the polymerization of nanoparticles.

SFEP alone is useful, however, several challenges still exist that cannot be achieved using traditional SFEP to create polymeric NPs (Zhang, G.; Niu, A.; Peng, S.; Jiang, M.; Tu, Y.; Li, M.; Wu, C. Acc. Chem. Res. 2001, 34, 249-256), including the preparation of monodisperse, sub-100 nm NPs at high solids content and the synthesis of NPs incorporating functional groups and cross-links as is found with the subject invention. The incorporation of cross-links is especially important as they maintain structural integrity, preventing the NPs from dissolution in good solvents or matrix materials, greatly expanding their utility (Dullens, R. R. A.; Claesson, M.; Derks, D.; van Blaaderen, A.; Kegel, W. K. Langmuir 2003, 19, 5963-5966 and Dullens, R. R. A.; Claesson, E. M.; Kegel, W. K. Langmuir 2004, 20, 658-664.).

The subject invention is a facile microwave methodology that overcomes several major challenges associated with SFEP and allows the preparation of narrow dispersity, cross-linked NPs with various functional groups in the critical sub-50 nm range. As an alternative to using a two-stage approach to control the NP size (Song, J.-S.; Tronc, F.; Winnik, M. A. J. Am. Chem. Soc. 2004, 126, 6562-6563), cross-linkers with enhanced reactivity are employed to effect cross-linking through a one-step process without detrimental effects on NP size or dispersity. This successful size control is realized by confining the cross-linking to intra-particle cross-linking rather than inter-particle cross-linking. In addition to this novel one-step strategy, the increased efficiency and control associated with microwave chemistry is exploited to prepare stable 20 nm NPs with included solids content up to about 10 wt %, or greater, which is in direct contrast to the 100+nm NPs that can be prepared at only 5 wt % included solids content using traditional techniques (Mouaziz, H.; Larsson, A.; Sherrington, D. C. Macromolecules 2004, 37, 1319-1323). By combining all of these features a novel method for preparing well-defined nanoparticles is herein disclosed that offers significant advantages when compared to previous methods (Zhang, W. Gao, J.; Wu, C. Macromolecules 1997, 30, 6388-6390; Ngai, T.; Wu, C. Langmuir 2005, 21, 8520-8525; and Bao, J.; Zhang, A. J. Appl. Polym. Sci. 2004, 93, 2815-2820.).

### BRIEF SUMMARY OF THE INVENTION

An object of the present invention is to provide a one-step process for microwave preparation polymeric nanoparticles having high solid content utilizing a surfactant-free solution, wherein selected cross-linking agents create intra-particle cross-linking.

Another object of the present invention is to furnish a one-step method for microwave preparation of sub-50 nm sized polymeric nanoparticles utilizing a surfactant-free solution comprising monomer, initiator, intra-particle cross-linkers, and solvent.

A further object of the present invention is to supply a one-step method for microwave preparation of sub-50 nm sized polymeric nanoparticles utilizing a surfactant-free solution comprising monomer, initiator, cross-linkers, solvent and functional group-containing co-monomers.

Still another object of the present invention is to disclose a one-step method for microwave preparation of sub-50 nm sized polymeric nanoparticles utilizing a surfactant-free solution comprising monomer, initiator, intra-particle producing cross-linkers, and solvent.

Yet a further object of the present invention is to describe a one-step method for microwave preparation of sub-50 nm sized polymeric nanoparticles utilizing a surfactant-free solution comprising monomer, initiator, intra-particle producing cross-linkers, solvent, and functional group-containing co-monomers.

Yet a further object of the present invention is to disclose sub-50 nm polymeric nanoparticles produced by a one-step microwave process utilizing a surfactant-free solution, wherein included cross-linking agents create intra-particles cross-linking.

Still an additional object of the present invention is to disclose sub-50 nm polymeric nanoparticles produced by a one-step microwave process utilizing a surfactant-free solution comprising monomer, initiator, intra-particle cross-linkers, hydrophilic solvent, and, if desired, functional group-containing co-monomers.

Specifically, disclosed are intra-cross-linked polymeric nanoparticles (NPs) and the method for producing these NPs. The subject invention provides an efficient, surfactant-free process for the preparation of these sub-50 nm particles from a surfactant-free solution comprising monomer, initiator, intra-particle producing cross-linkers, solvent, and, if selected, functional group-containing co-monomers.

By way of explanation concerning the basis of why the subject invention is such a vast improvement over previous nanoparticle preparation techniques, it is noted that for existing surfactant-free emulsion processes, the particle size is routinely above 100 nm and it has been a challenging issue to prepare sub-100 nm particles with high solid content, especially for cross-linked particles. In surfactant-free emulsion processes, usually polymerization of the monomers is initiated by a water-soluble initiator that initiates the polymerization of monomers in solution. When the polymer chains are long and hydrophobic enough, they collapse to form small polymer particles that are stabilized by the ionic groups generated from the initiator. The initially formed small polymer particles can trap monomers and thus act as nucleation seeds for further particle growth. Depending upon the colloidal stability of the particles, the particles may agglomerate into larger particles to reduce the total surface area when the particles are not stable enough. The subject invention is partially focused on the nucleation step of the process and specifically designed to increase the concentration of the nucleation seeds such that more nanoparticles can be formed and, accordingly, the critical size of the average nanoparticle reduced. As noted below, a carefully selected combination of various steps are used to increase the concentration of the nucleation in the subject invention. Water miscible solvent and more water soluble monomers are utilized to increase the concentration of monomers in solution with the subject invention over past methods. An optimized amount of initiator is used to generate high concentrations of free-radicals and to provide colloidal stability to the nanoparticles. In addition, microwave radiation is employed to facilitate the decomposition of the initiator and accelerate the polymerization process. Also, the choice of appropriate cross-linker is important to render the particle size similar to the particles without cross-linkers. With the subject method, highly monodispersed, cross-linked, sub-50 nm nanoparticles are synthesized with solid content up to about 10 wt % or more. The subject microwave synthesis process improves the efficiency of the overall polymerization by shortening the necessary reaction times. Further, the versatility of the subject approach allows for various functional groups to be incorporated into the nanoparticles by copolymerization and this can lead to a variety of extremely useful and novel functionalized nanoparticles for applications in biological imaging, biomedical immunoassays, controlled release schemes and the like.

Further objects and aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a graph of particle size as a function of reaction time at 70° C. under microwave power of 23±2 W (0.125 M MMA, 9.25 mM KPS) with a) 0 mol % EGDM in water; b) 0 mol % EGDM in 25 wt % acetone/water; c) 0.5 mol. % EGDM in water; and d) 0.5 mol % EGDM in 25 wt % acetone/water.

FIG. 2 is a graph showing DLS (dynamic light scattering) size of NPs prepared in water with 1 mol % of cross-linkers. Reaction conditions: 70° C., 28±2 W, 1 h, 0.125 M MMA, 9.25 mM KPS.

FIG. 3 is a graph showing DLS (dynamic light scattering) size of NPs prepared in water with 3 mol. % of cross-linkers. Reaction conditions: 70° C., 28±2 W, 1 h, 0.125 M MMA, 9.25 mM KPS.

FIG. 4 is a graph showing DLS size of NPs prepared in 25 wt. % acetone/water with 1 mol. % of cross-linkers. Reaction conditions: 70° C., 28±2 W, 1 h, 0.125 M MMA, 9.25 mM KPS.

FIG. 5 is a graph showing DLS size of NPs prepared in 25 wt. % acetone/water with 3 mol. % of cross-linkers. Reaction conditions: 70° C., 28±2 W, 1 h, 0.125 M MMA, 9.25 mM KPS.

FIG. 6 is a graph showing particle size as a function of temperature under microwave power of 23±2 W in 25 wt. % acetone/water (0.125 M MMA, 9.25 mM KPS).

FIG. 7 is a graph showing particle size as a function of microwave power at 70° C. in 25 wt. % acetone/water (0.125 M MMA, 1.5 mol. % MBA, 9.25 mM KPS).

FIG. 8 shows a microwave profile for temperature (° C.) versus time (min.) for a 25 wt % acetone/water solution at 28±2 W.

FIG. 9 shows a microwave profile for power (W) versus time (min.) for a 25 wt % acetone/water solution at 70° C.

FIG. 10 shows a microwave profile of pressure (torr) versus time (min./20) for a 25 wt % acetone/water solution at 70° C. and 28±2 W.

FIG. 11 shows an AFM image of PMMA NPs synthesized with 0.125 M MMA and 9.25 mM KPS at 70° C. under microwave power 28±2 W for 1 hour in 25 wt % acetone/water and 0 mol % cross-linker.

FIG. 12 shows a section analysis of the NPs seen in FIG. 11.

FIG. 13 shows an AFM image of PMMA NPs synthesized with 0.125 M MMA and 9.25 mM KPS at 70° C. under microwave power 28±2 W for 1 hour in 25 wt % acetone/water and 1 mol % MBA.

FIG. 14 shows an AFM image of PMMA NPs synthesized with 0.125 M MMA and 9.25 mM KPS at 70° C. under microwave power 28±2 W for 1 hour in 25 wt % acetone/water and 1 mol % EGDA.

FIG. 15 displays nanoparticle diameter measured in both water and DMF for cross-linked nanoparticles prepared with 0.125 M MMA, 9.25 mM KPS in 25 wt % acetone/water solution and the cross-linker used is either 1 mol % or 3 mol % of EGDM with reaction conditions: 70° C., microwave power 28±2 W, 1 hour.

FIG. 16 shows nanoparticle diameter measured in both water and DMF for cross-linked nanoparticles prepared with 0.125 M MMA, 9.25 mM KPS in 25 wt % acetone/water solution and the cross-linker used is either 1 mol % or 3 mol % of EGDA with reaction conditions: 70° C., microwave power 28±2 W, 1 hour.

FIG. 17 presents nanoparticle diameter measured in both water and DMF for cross-linked nanoparticles prepared with 0.125 M MMA, 9.25 mM KPS in 25 wt % acetone/water solution and the cross-linker used is either 1 mol % or 3 mol % of MBA with reaction conditions: 70° C., microwave power 28±2 W, 1 hour.

FIG. 18 depicts DLS size results for nanoparticles prepared at different temperatures.

FIG. 19 shows DLS size results for nanoparticles prepared under different microwave power levels.

FIG. 20 illustrates DLS nanoparticle size as a function of acetone content in the solvent.

FIG. 21 presents DLS nanoparticle size as a function of the amount of HEMA co-monomer (2-hydroxyethyl methacrylate, a functionalized monomer) in the reaction mixture.

FIG. 22 shows DLS size results for nanoparticles as a function of KSP (potassium persulfate, an initiator) concentration.

FIG. 23 presents DLS nanoparticle size as a function of solids content.

FIG. 24 discloses DLS size results for nanoparticles prepared at different solids content in 40 wt % acetone/water.

### DETAILED DESCRIPTION OF THE INVENTION

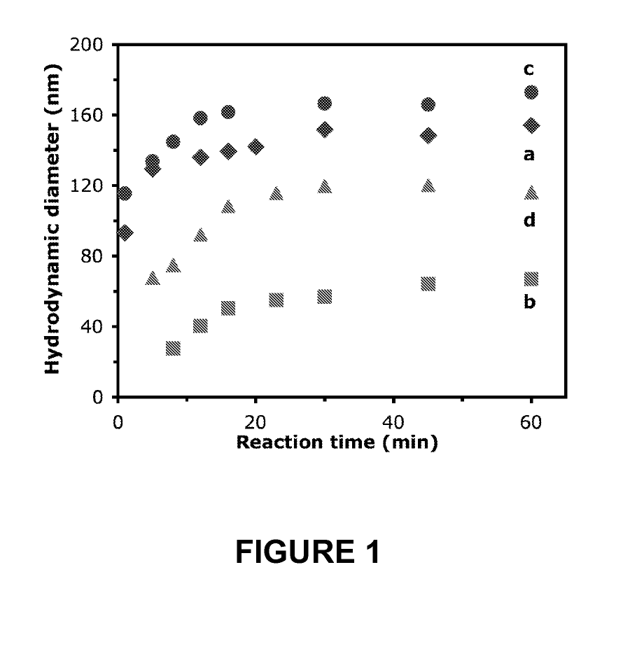

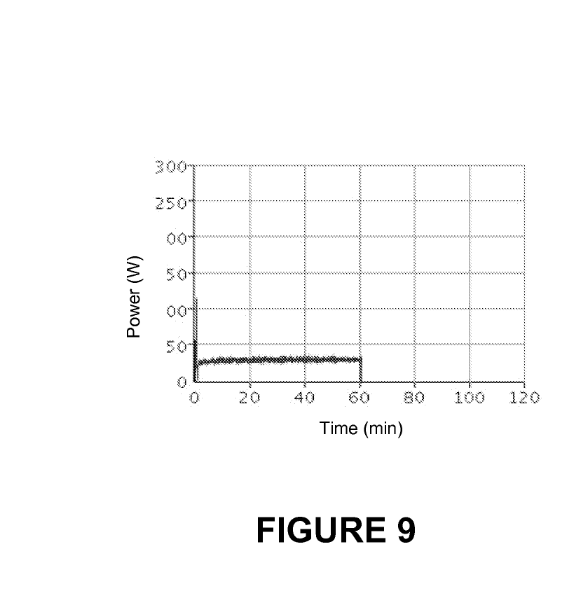

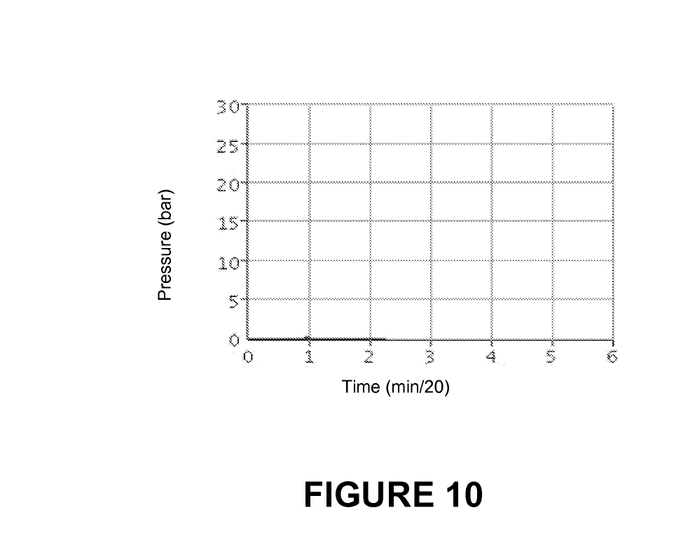

Referring more specifically to the drawings, for illustrative purposes the present invention is embodied in the examples and results generally shown in FIG. 1 through FIG. 25. It will be appreciated that the method may vary as to the specific steps and sequence, without departing from the basic concepts as disclosed herein.

The subject invention is an emulsifier-free and microwave initiated polymerization process (and the produced nanoparticles) utilized to generate well-defined sub-50 nm polymeric nanoparticles with varying amounts of cross-links, functional groups, and included solids. Depending on the exact nature of the desired polymeric nanoparticle, the composition of the reaction mixture (solution or colloidal suspension) may vary. Comprising the microwave polymerizable subject mixture is a monomer, initiator, cross-linker, hydrophilic solvent, and functionalized co-polymer, if desired.

As is supported by specific examples further below, the following listing presents illustrative examples, not by way of limitation, but by way of explanation, of suitable chemicals and conditions for practicing the subject invention:

1) Monomers (first co-monomer, if employed with a second co-monomer) are selected from chemical species that polymerize via traditional addition polymerization mechanisms and include alkenes (double bond containing molecules) such as the simplest ethene to more complex structures such as vinyl group containing molecules and derivatives such as acrylates or alkyl acrylates like methyl methacrylate, ethyl methacrylate, and similar compounds, and equivalent alkene containing structures having one or more double bonds that are polymerizable via addition polymerization are considered to be within the realm of this disclosure.

2) Initiators are water-soluble entities that produce a free radical upon activation and are utilized in the subject invention for initiating addition polymerization. Usually, the concentration of initiator is less than about 20 wt % of the monomers. Subject initiators include persulfates such as potassium persulfate, peroxydisulfates, azo compounds, peroxides, and equivalent compounds. These initiators must be capable of activation (generation of one or more free radicals) by application of microwave radiation.

3) Cross-linkers are employed in the subject invention to produce, mostly, intra-particle cross-links within the subject polymeric nanoparticles. Typically, the concentration of cross-linkers is less than about 5 mol % of the monomers. Exemplary cross-linkers include, but are not limited to, ethylene glycol dimethacrylate, ethylene glycol diacrylate, N,N′-methylenebisacrylamide, and other equivalent substances. Under the reaction conditions of the subject invention, these cross-linking agents produce a majority of intra-particle cross-links, as opposed to inter-particle cross-links, which permits the microwave-initiated production of nanoparticles with high percentage yields for sub-50 nm polymeric nanoparticles.

4) Solvents are hydrophilic and water-based and range from 100% water to various water/organic compound mixtures, wherein the organic compound is selected from a wide range of candidates such as aldehydes/ketones (e.g.: acetone and the like), alcohols (e.g.: methanol, ethanol, propanol, butanol, and the like), and other equivalent water-soluble solvents.

5) Functionalized monomers (second co-monomers if included with a bulk first co-monomer) are chemicals that polymerize into or with the bulk of the nanoparticle that provides useful functional groups within or on a polymeric nanoparticle. The concentration of the functionalized monomers is usually in the range of about 0 mol % to about 20 mol % of the total monomers, depending on the targeted surface functionality density. Exemplary functionalized monomers include acrylic acid, methacrylic acid, itaconic acid, 2-acrylamino-2-methyl-1-propane sulphonic acid, ethylene glycol methacrylate phosphate, N-(hydroxymethyl)acrylamide, poly(ethylene glycol) monomethacrylate, 2-hydroxyethyl methacrylate (HEMA), 2-aminoethyl methacrylate, 1-vinylimidazole, and sugar-based methacrylate or acrylate, to provide carboxylic acid, sulphonic acid, phosphoric acid, hydroxyl, amine, imidazole and sugar surface functionalities.

6) The microwave power range is preferably anywhere from about 0 W to about 300 W or higher, which is limited by the maximum power of the microwave.

7) The reaction temperature for a subject polymerization reaction is preferably in the range of about 50° C. to about 100° C., but could be lower or higher if a particular reaction requires such variation.

Specifically, as shown in FIG. 1, when methyl methacrylate (MMA) was polymerized with potassium persulfate (KPS) in water (letter “a” diamond-symbols in FIG. 1) or in 25 wt % acetone/water solution (letter “b” square-symbols in FIG. 1), the particles reached their final size (characterized by dynamic light scattering (DLS)) within about 30 min under 23±2 W microwave irradiation. Without cross-linker, the final size was reduced from 155 nm in water to 65 nm in 25 wt % acetone/water. This size reduction in acetone/water solution was attributed to the greater number of nucleating seeds resulting from the increased solubility of the monomer in acetone/water solution. While adding cross-linker ethylene glycol dimethacrylate (EGDM) caused a small increase in NP size in water (letter “c” circle-symbols in FIG. 1), 155 nm (0 mol. % EGDM) vs 170 nm (0.5 mol. % EGDM); a dramatic size increase was seen in acetone/water solution (letter “d” triangle-symbols in FIG. 1), 65 nm (0 mol. % EGDM) vs 120 nm (0.5 mol. % EGDM), suggesting a different nucleation mechanism involved in acetone/water solution possibly due to inter-particle cross-linking, particularly when the number concentration of the nucleating seeds was significantly increased in acetone/water solution.

Based on the observed high sensitivity of the NP size to the reaction conditions in the presence of cross-linkers, it is proposed that two factors are critical in determining inter-particle/intra-particle cross-linking and hence the NP size: the concentration of the NP seeds and the propagation rate coefficient kₚ of the cross-linkers. To confirm this hypothesis, the following experiments were conducted: 1) NP synthesis in water with cross-linkers of different kₚ, representing conditions of low particle seed concentration and 2) NP synthesis in 25 wt % acetone/water solution with cross-linkers of different kₚ, representing conditions of high particle seed concentration. Two other cross-linkers, ethylene glycol diacrylate (EGDA) and N,N′-methylenebisacrylamide (MBA), were studied in addition to EGDM. The kₚ values for the corresponding monomeric methacrylate, acrylate and acrylamide are ˜650-800 M⁻¹s⁻¹ (50° C.) (Beuermann, S.; Buback, M. Prog. Polym. Sci. 2002, 27, 191-254), ˜11,600-16700 M⁻¹s⁻¹ (20° C.) (Beuermann, S.; Buback, M. Prog. Polym. Sci. 2002, 27, 191-254) (Beuermann, S.; Buback, M. Prog. Polym. Sci. 2002, 27, 191-254) and ˜20,000-30,000 M⁻¹s⁻¹ (20° C.) (Ganachaud, F.; Balic, R.; Monteiro, M. J.; Gilbert, R. G. Macromolecules, 2000, 33, 8589-8596), respectively. Therefore, the kₚ values for the corresponding cross-linkers should follow the order of MBA>EGDA>EGDM.

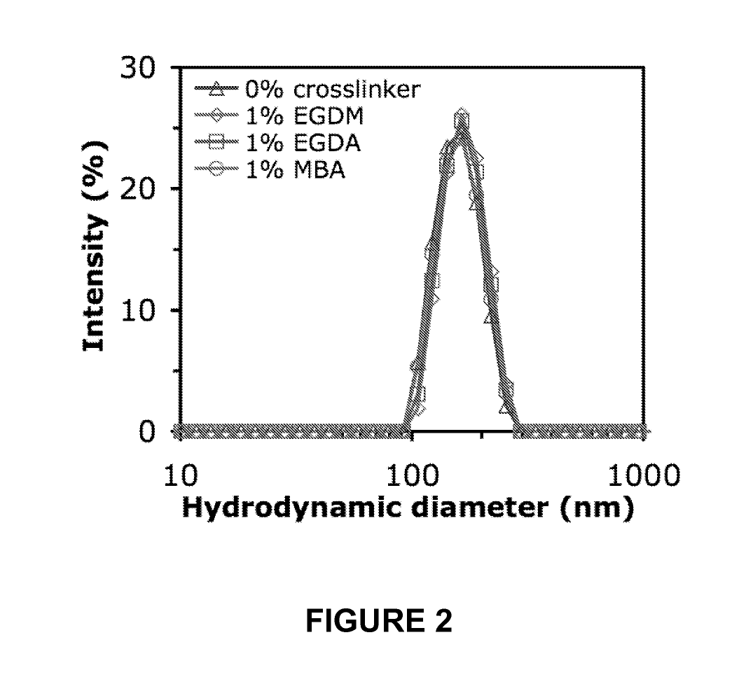

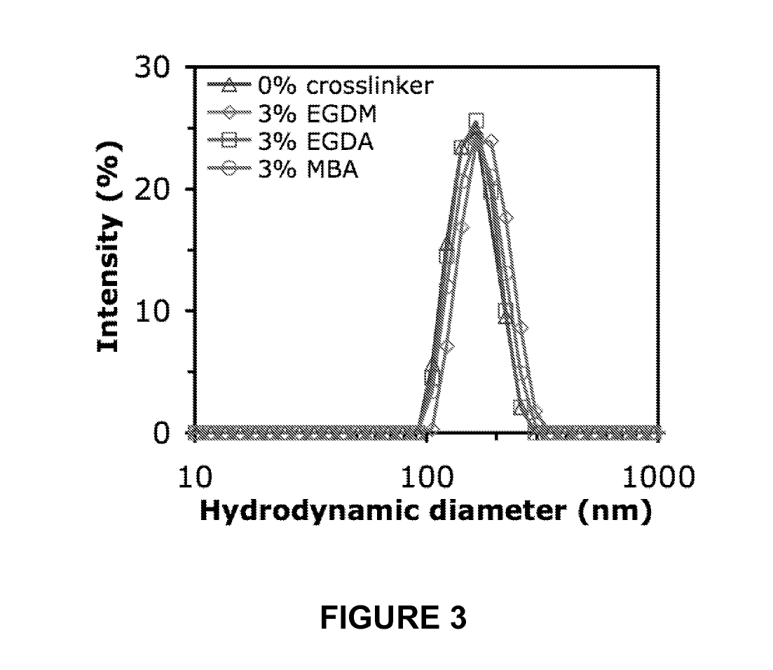

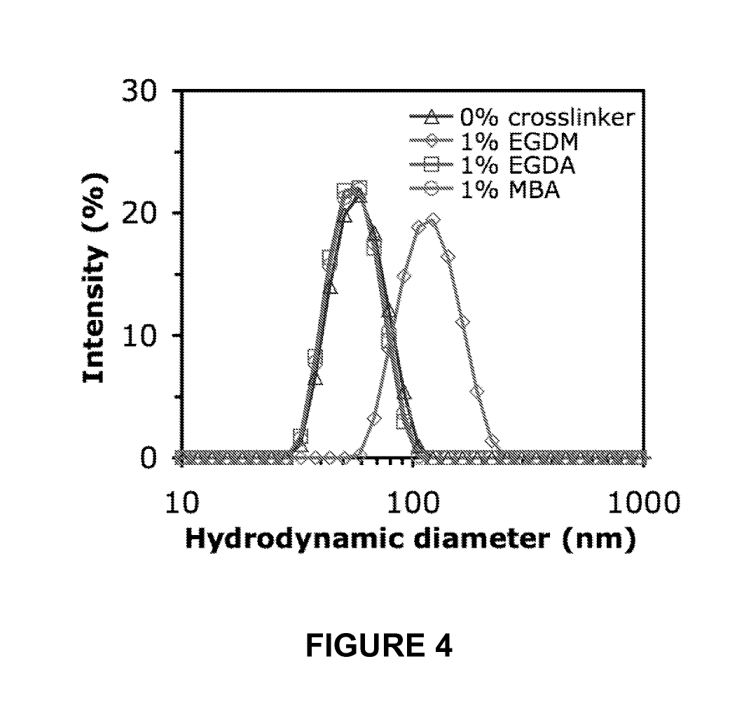

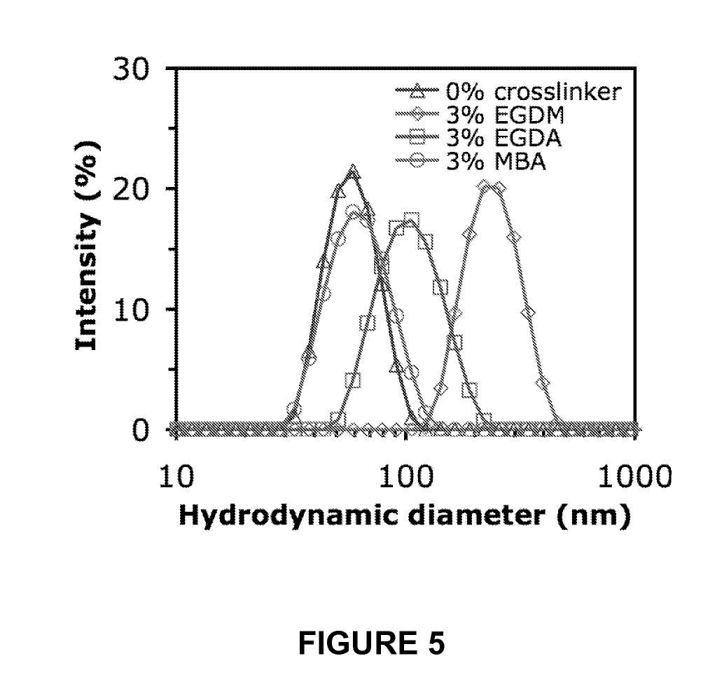

As shown in FIGS. 2 and 3, when prepared in water, the particle size (˜155 nm) was not affected by the type and amount of cross-linkers, indicating that inter-particle cross-linking was negligible due to the low particle concentration (˜4.9×10¹² ml⁻¹). However, in 25 wt % acetone/water (FIGS. 4 and 5), the particle concentration increased by ˜25 times (particle concentration was calculated from the mass of the monomer and the particle diameter, assuming spherical NP and 100% monomer conversion), resulting in significantly enhanced inter-particle cross-linking for cross-linkers with lower kₚ. In 25 wt % acetone/water, for 1 mol % cross-linker (FIG. 4), EGDM with the lowest kₚ led to larger particle size (˜115 nm) than NPs without cross-linker and with 1 mol % EGDA/MBA (˜55 nm); while for 3 mol % cross-linker (FIG. 5), particles with EGDA started to increase (˜100 nm) and particles with EGDM displayed a further enlargement (˜230 nm), consistent with the corresponding kₚ order of the crosslinkers. In all cases, the NP size (55-60 nm) was well controlled with MBA, the cross-linker with the highest kₚ and this is attributed to the decreased occurrence of inter-particle cross-linking. The cross-linked NPs showed narrow polydispersity and maintained their integrity in N,N-dimethylformamide (DMF). In addition, NPs prepared under thermal heating conditions displayed no control for cross-linked NPs, resulting in poorly defined systems.

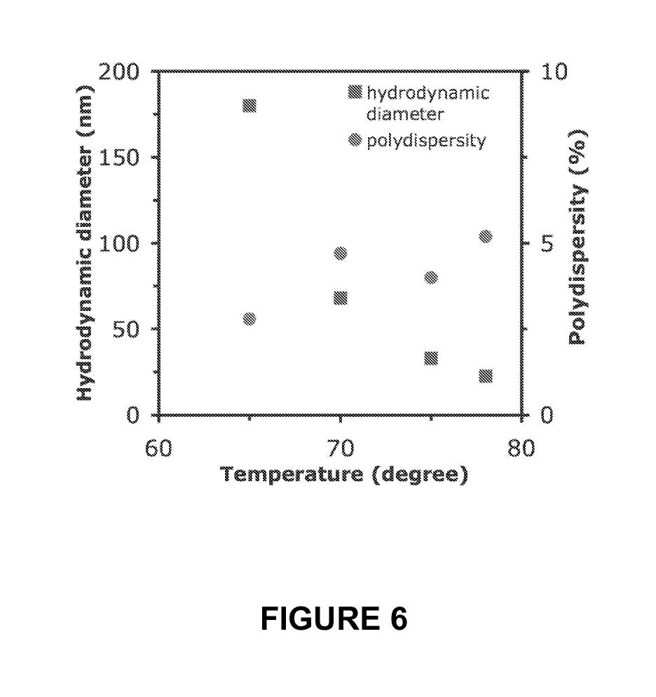

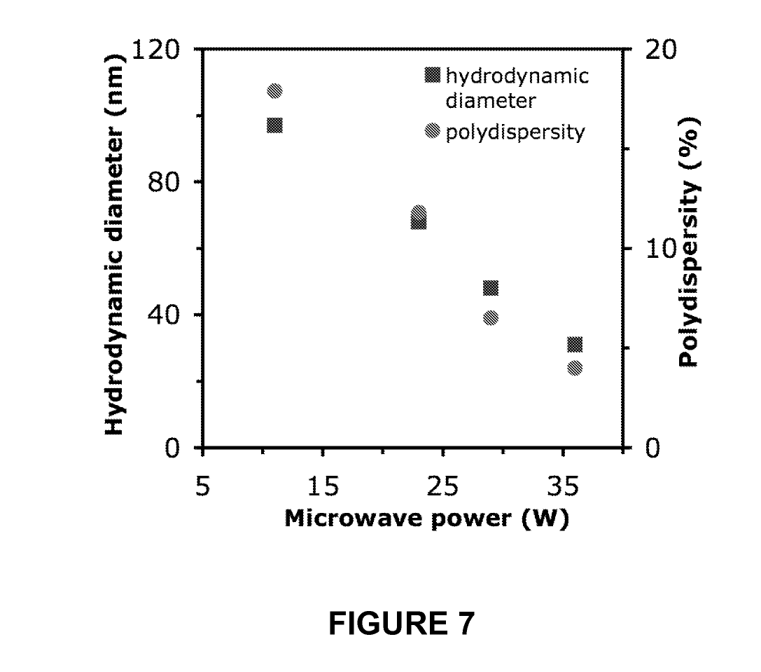

In contrast to thermal heating reactions, one of the advantages of microwave systems is the ability to control other facets of the reactions. In this respect, microwave polymerization was examined in the superheated state of the solution by increasing the temperature from 65° C. to 78° C. (azeotropic point of 25 wt. % acetone/water is 68° C.) which showed a significant reduction in NP size from 180 nm at 65° C. to 23 nm at 78° C. (FIG. 6). In addition, for polymerizations performed at the same temperature (i.e. 70° C.), an impressively wide range of diameters (100 to 30 nm) could be obtained by varying the microwave power (11 to 36 W) (FIG. 7). Control reactions without KPS did not produce any colloidal NPs or polymers, indicating that polymerization was not initiated by just microwave irradiation, without an initiator. The dramatic reduction in NP size suggests enhanced radical influx in the solution, which further implies that microwave can dielectrically couple with the persulfate anions to accelerate the decomposition of the initiator.

Having positively demonstrated the ability to prepare cross-linked NPs with diameters less than 50 nm, the versatility of this technique was further established by increasing the solids content and by the inclusion of functionalized monomers, such as 2-hydroxyethyl methacrylate (HEMA) into the polymerization system. After a high-throughput analysis of various reaction parameters (see below), it was found that decreasing the solvent polarity to 40 wt % acetone/water while increasing the reaction temperature (80° C.) and microwave power (50±2 W) allowed the preparation of cross-linked, HEMA functionalized NPs at unprecedented solids content, from 14 nm at 5.6 wt % to 41 nm at 12.6 wt % solids (molar ratio of MBA:HEMA:MMA:KPS=1.0:1.6:30.7:1.6). In each case, the monomer conversion was essentially quantitative (96-100%) and stable colloidal solutions without any agglomeration were obtained.

Clearly, a novel strategy for controlled preparation of cross-linked polymeric NPs is disclosed herein. Key to this development is the use of crosslinkers with enhanced reactivity and controlled microwave reaction procedures. The subject invention proves to be a powerful tool for the synthesis of cross-linked, functionalized, if desired, NPs under high solids content and surfactant-free conditions. In addition, these findings based on exemplary PMMA data (e.g.: in one case, narrow dispersity, cross-linked PMMA NPs with hydroxy functional groups in the critical sub-50 nm range were prepared in high yield) can be easily extended to other polymers and other emulsion polymerization techniques.

### DETAILED EXPERIMENTAL EXAMPLES

### Example 1

### Synthesis

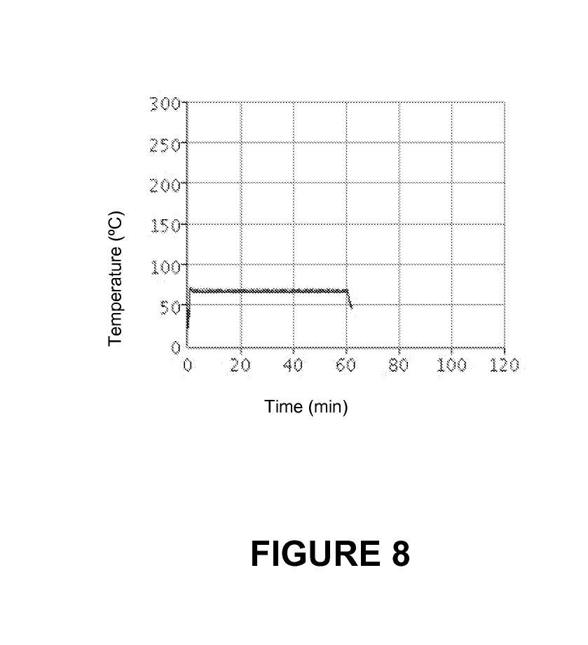

All chemicals were purchased from Aldrich and were used as received except for the monomers which were vacuum distilled before use. The polymer nanoparticles were prepared with a 2.45 GHz microwave reactor having a maximum power of 300 W (Initiator Eight, Biotage). In an example synthesis of PMMA nanoparticles, 0.01 g (37.0 μmol) potassium persulfate was added to a vial, followed by the addition of 4 ml of deionized water (Millipore, 18 MΩ·cm) pre-purged with nitrogen for about 20 min and 0.05 g (0.50 mmol) methyl methacrylate. The vial was then sealed, pre-stirred to dissolve the initiator before being subjected to microwave irradiation. The microwave reactions were carried out under nitrogen cooling at a fixed temperature for a desired reaction time (all reactions were allowed to heat for one hour for final size comparison, except for the particle size versus time studies). The desired temperature was typically reached within about one minute, depending on the reaction conditions. The microwave power was adjusted by tuning the cooling nitrogen flow and was limited by the achievable pressure of the cooling nitrogen for a given reaction. The stability of the microwave power can affect the size distribution of the nanoparticles and it is important to keep the microwave power stable to get narrow size distribution. Typical microwave reaction profiles are shown in FIGS. 8, 9, and 10.

Nanoparticle synthesis was also performed under similar conditions to microwave reactions with conventional oil bath heating for comparison. Briefly, sealed vials with the desired amount of reactants and solvent were prepared similarly as in microwave reactions, immersed into 70±2° C. oil bath and heated while stirring for about 12 hours. When reactions by thermal heating were carried out in water without cross-linkers, serious flocculation was observed; while reactions by thermal heating in 25 wt % acetone/water gave stable colloidal solutions. The size of the nanoparticles prepared under microwave and thermal heating conditions is summarized in Table 1. It is clear that thermal heating did not have the same ability to control the particle size as did microwave heating.

### Example 2

### Nanoparticle Characterizations

The hydrodynamic diameters of the nanoparticles were determined by dynamic light scattering (DLS) technique on a Zetasizer Nano-ZS (Malvern Instrument) using a 633 nm laser and the scattered light was collected at 173°. The as-prepared colloidal solutions were diluted with Millipore water until the size was no longer concentration dependant and a well-defined correlation curve was obtained. All measurements were performed at 25±0.1° C. Z-average diameter and polydispersity were automatically analyzed in the cumulant mode by the Malvern Zetasizer software and was reported as the average of three measurements.

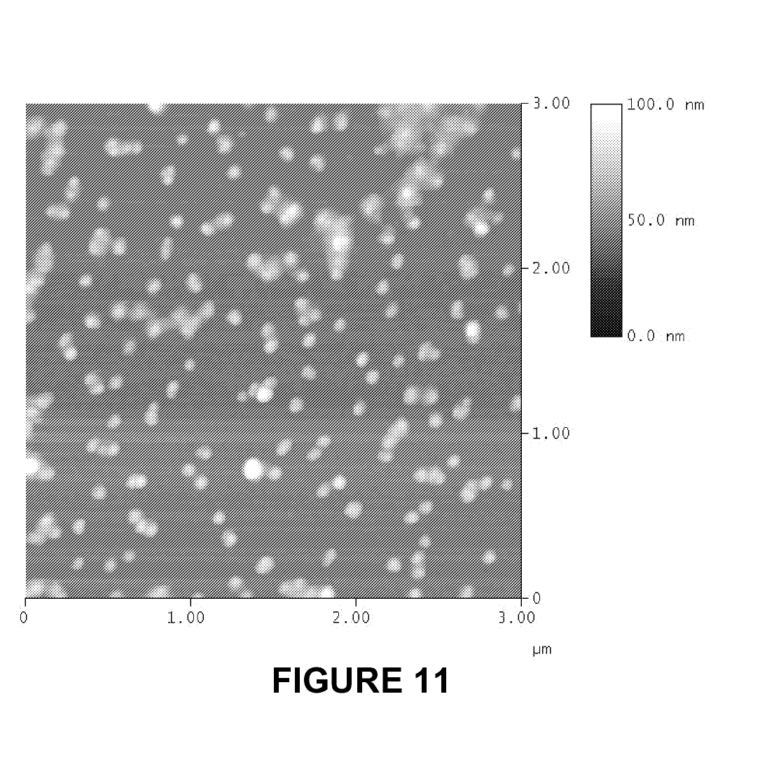

Atomic force microscope (AFM) images (see FIGS. 11, 12, 13, and 14) were obtained using a Dimension 3000 (Digital Instruments) scanning force microscope in the tapping mode. AFM samples were prepared under ambient conditions by evaporating diluted colloidal solutions on clean silicon wafer. Particle size was determined from height analysis. The particle size analyzed from AFM was generally smaller than that determined from DLS.

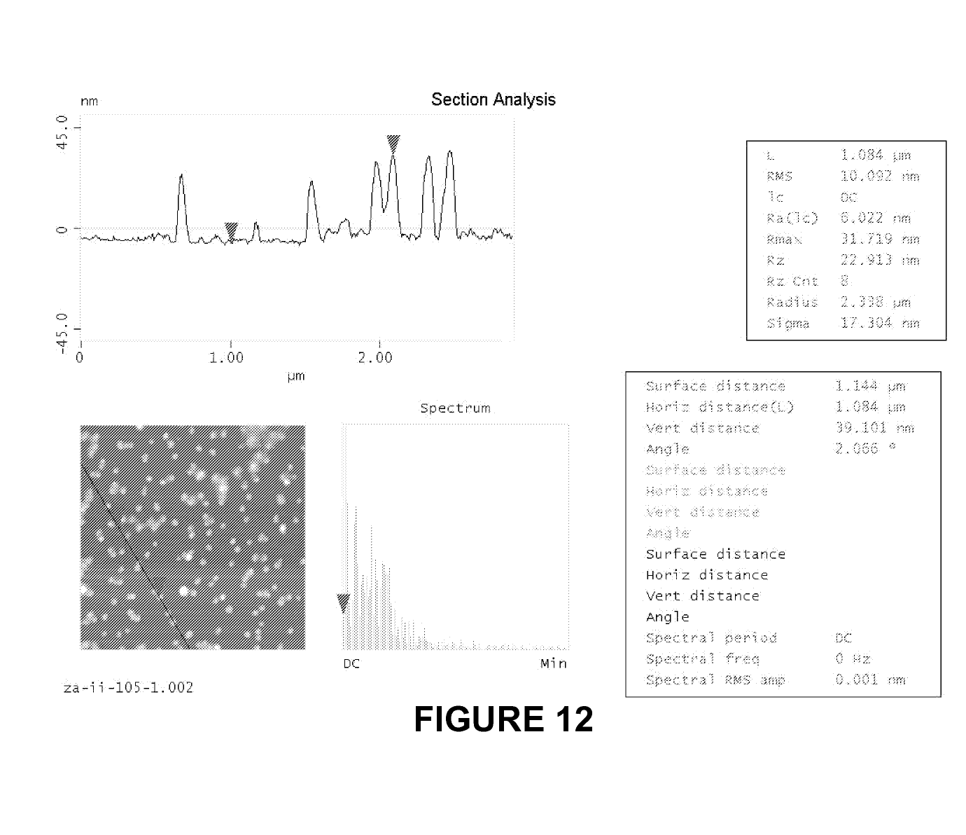

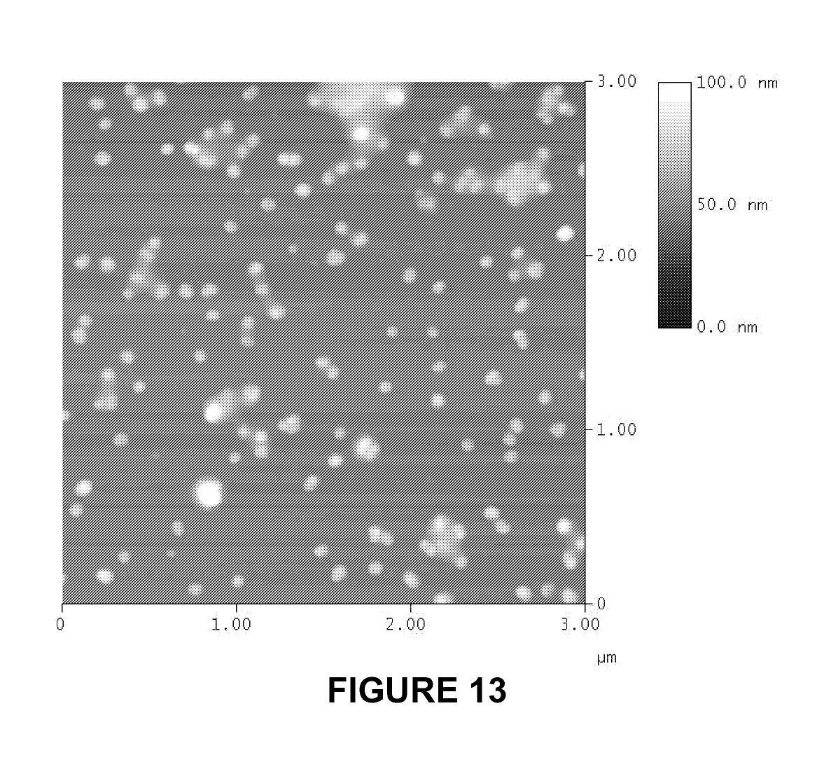

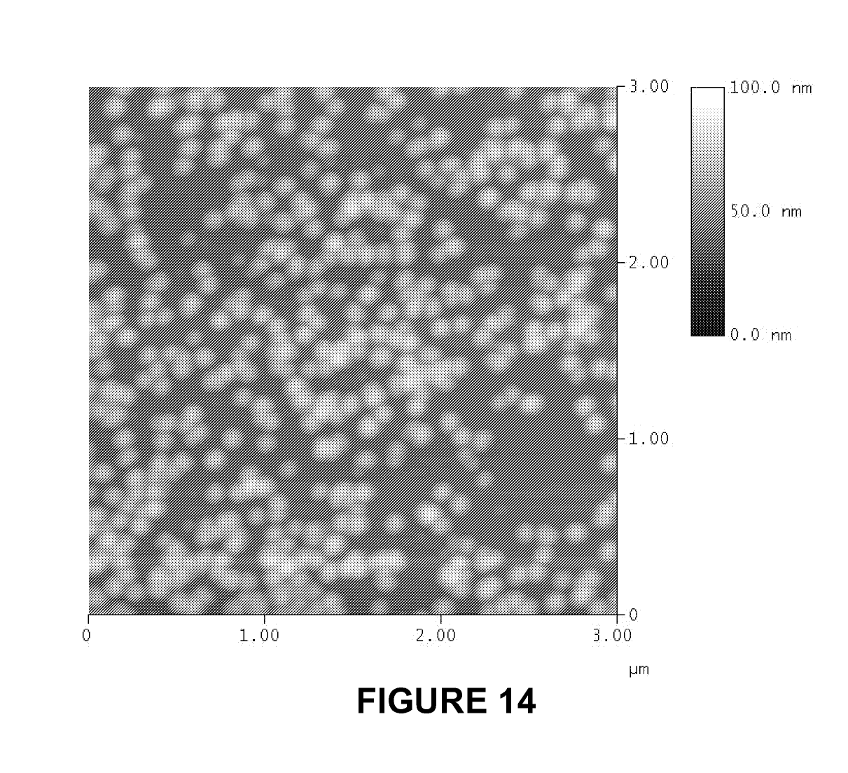

The representative AFM images (FIGS. 11, 12, 13, and 14) of PMMA NPs synthesized with 0.125 M MMA and 9.25 mM KPS at 70° C. under microwave power 28±2 W for 1 hour in 25 wt % acetone/water contain: 0 mol % cross-linker (FIG. 11) (with section analysis of NPs in FIG. 11 shown in FIG. 12); 1 mol % MBA (FIG. 13); and 1 mol % EGDA (FIG. 14).

### Example 3

### Nanoparticle Swelling Studies

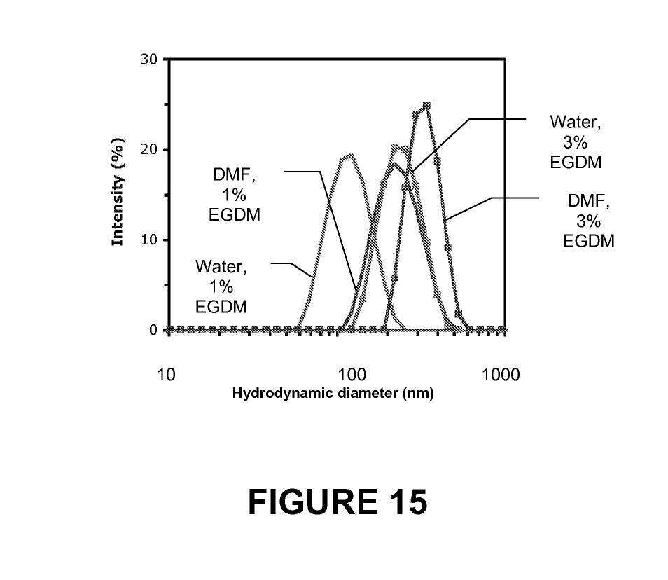

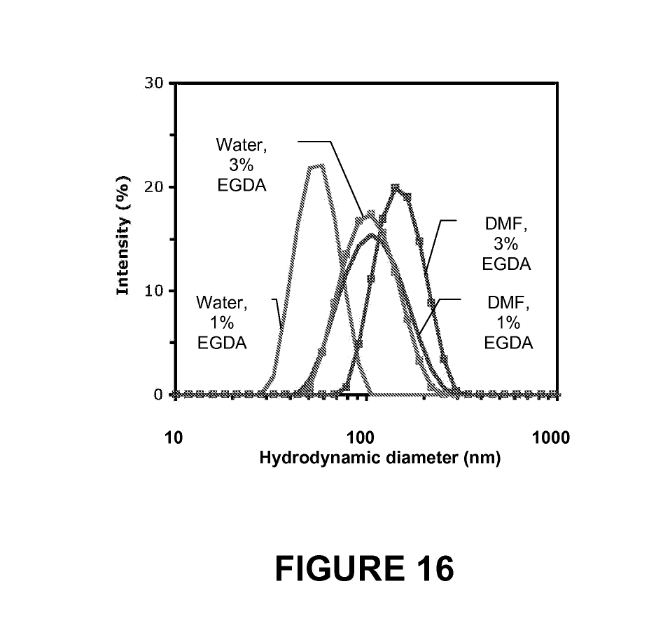

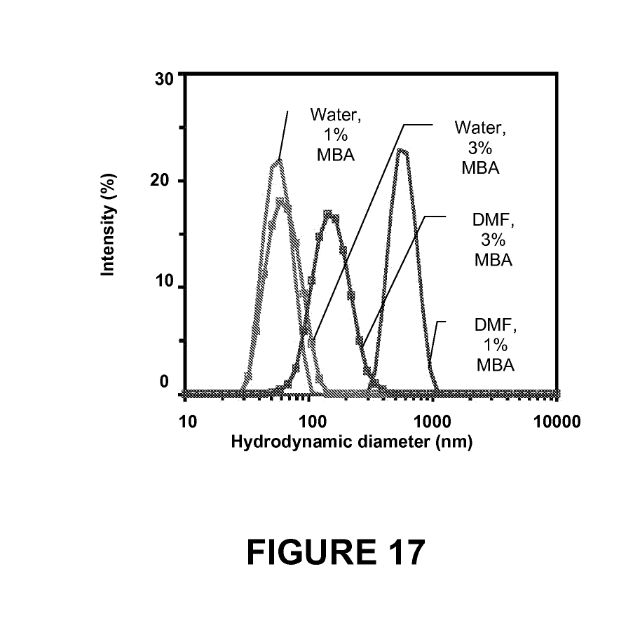

The incorporation of cross-linkers into nanoparticles was qualitatively characterized by swelling the nanoparticles in DMF. Briefly, 2˜3 drops of the as-prepared colloidal solutions were mixed with 1 ml DMF to form a uniform solution and size measurement was performed after 1˜2 hours of swelling in DMF. The refractive index of DMF was used as the refractive index of the dispersant. FIGS. 15, 16, and 17 show the relative size of the corresponding cross-linked nanoparticles measured in both water and DMF, and the nanoparticle diameter and swelling ratio (diameter measured in DMF/diameter measured in water) are summarized in Table 2. FIGS. 15, 16, and 17 present cross-linked nanoparticles prepared with 0.125 M MMA, 9.25 mM KPS in 25 wt % acetone/water solution and the cross-linker used was either 1 mol % or 3 mol % of EGDM (FIG. 15), EGDA (FIG. 16), and MBA (FIG. 17). Reaction conditions for all three: 70° C., microwave power 28±2 W, 1 hour.

### Example 4

### Nanoparticle Characterizations

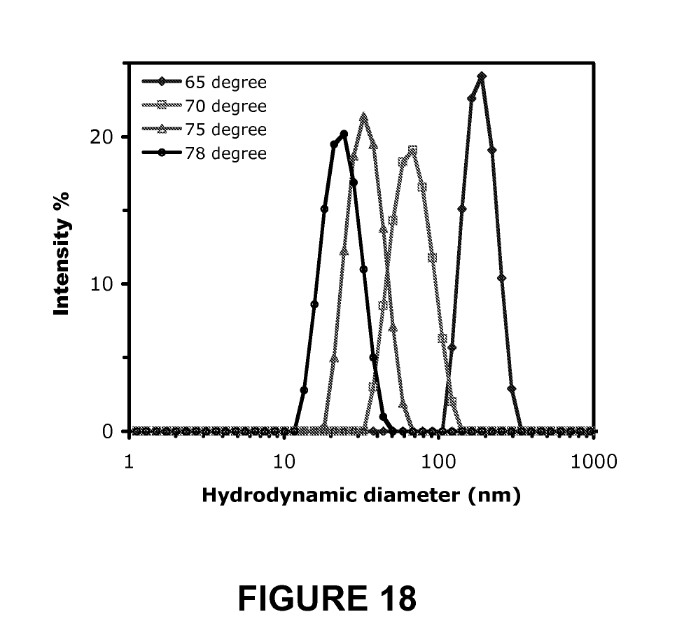

FIGS. 18-24 present various DLS size results for nanoparticles prepared under different conditions.

FIG. 18 relates DLS size results for nanoparticles prepared at different temperatures (superheating at 70° C., 75° C. and 78° C.) with 0.125 M MMA, 9.25 mM KPS in 25 wt % acetone/water under microwave power of 23±2 W.

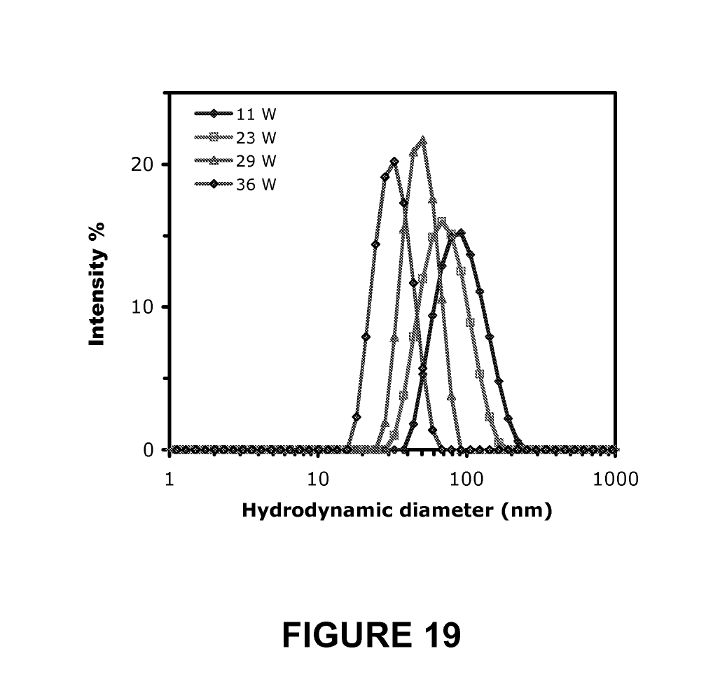

FIG. 19 presents DLS size results for nanoparticles prepared under different microwave power at 70° C. with 0.125 M MMA 1.5 mol % MBA, 9.25 mM KPS in 25 wt % acetone/water.

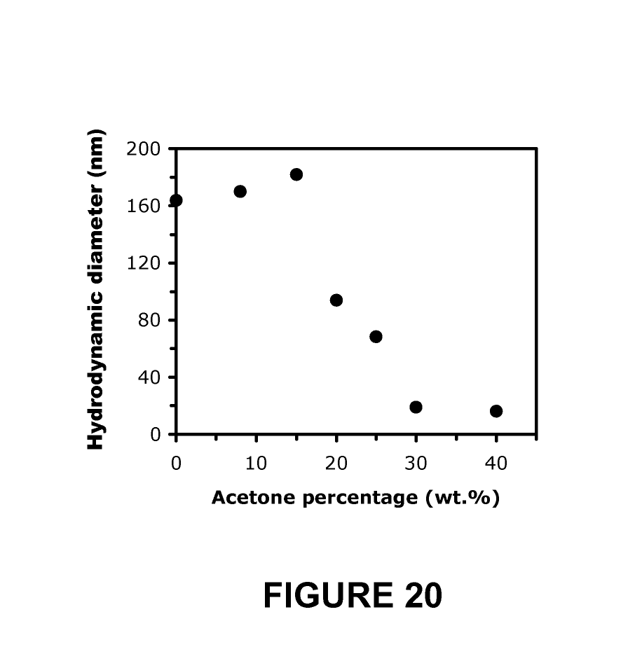

FIG. 20 depicts nanoparticle size as a function of acetone content at 70° C. under microwave power of 23±2 with 0.125 M MMA, 9.25 mM KPS. At least two factors were identified that affect the particle size upon addition of acetone: 1) solubility of the monomers and 2) solvation of KPS residues on the particle surface. Addition of acetone increases monomer concentration but decreases dielectric constant of the solution. Increased monomer concentration leads to reduced particle size; while decreased dielectric constant gives rise to less stable particles leading to increased particle size. FIG. 20 shows the complex interplay of these two factors on the particle size.

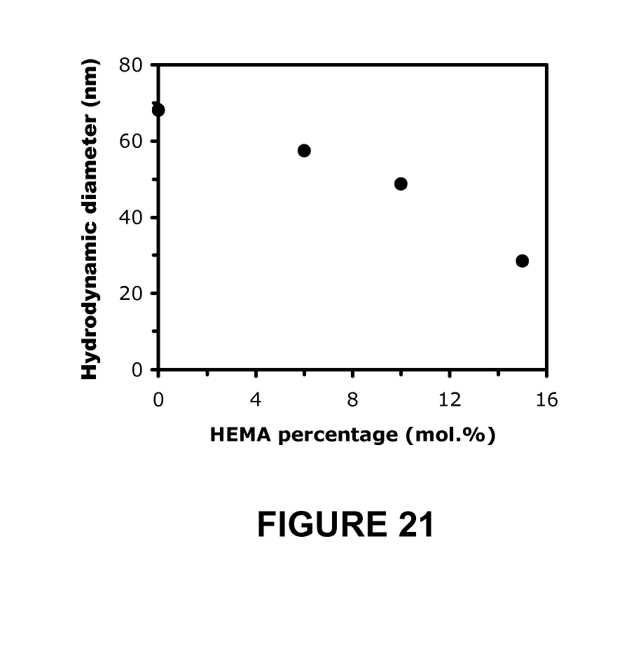

FIG. 21 discloses nanoparticle size as a function of the amount of HEMA co-monomer (an exemplary functionalized co-monomer) at 70° C. under microwave power of 23±2 W with (MMA+HEMA) total concentration 0.125 M, 9.25 mM KPS in 25 wt % acetone/water.

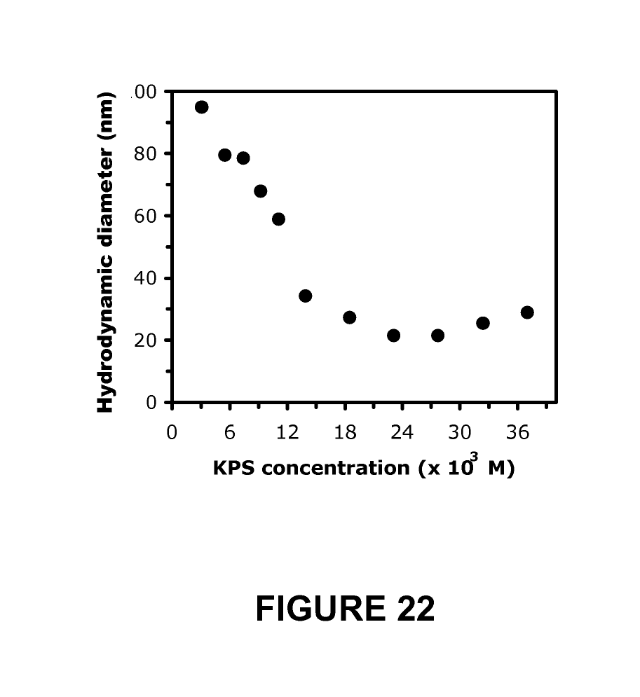

FIG. 22 depicts nanoparticle size as a function of KPS concentration at 70° C. under microwave power of 23±2 W with 0.125 M MMA in 25 wt % acetone/water.

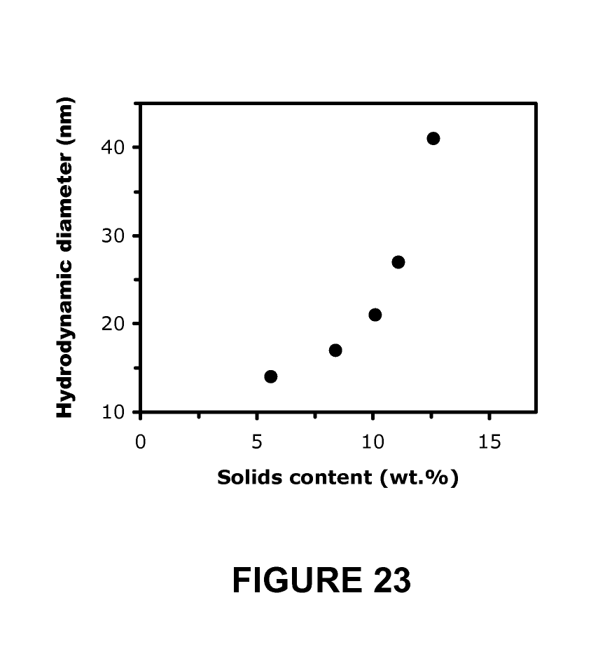

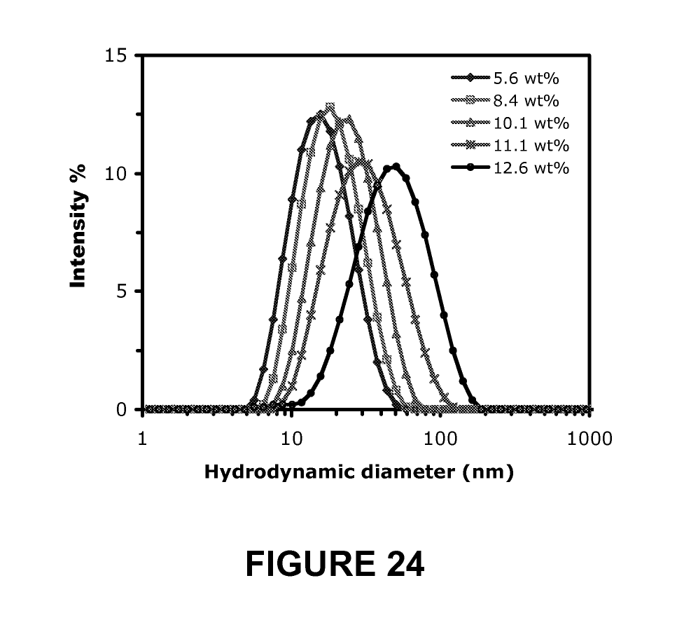

FIGS. 23 and 24 related nanoparticle size variation with solids content. FIG. 23 presents DLS nanoparticle size as a function of general wt % of solids and FIG. 24 displays DLS size results for nanoparticles prepared at different solids content in 40 wt. % acetone/water under microwave power of 50±3 W at 80° C. (MBA:HEMA:MMA:KPS=1:1.6:30.7:1.6).

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a method to address each and every problem sought to be solved by the present invention, for it to be encompassed by the present claims. Furthermore, no element or method step in the present disclosure is intended to be dedicated to the public regardless of whether the element or method step is explicitly recited in the claims. No claim element herein is to be construed under the provisions of 35 U.S.C. 112, sixth paragraph, unless the element is expressly recited using the phrase “means for.”

TABLE 1
Comparison of nanoparticle diameter for the nanoparticles prepared
under microwave and thermal heating conditions with 0.125 M MMA
and 9.25 mM KPS.
Microwave conditions: 70° C., microwave power 28 ± 2 W, 1 hour.
Thermal heating conditions: 70° C., 12 hours.

| | Nanoparticle diameter (nm) and polydispersity | | | |
|---|---|---|---|---|
| | Microwave heating | | Thermal heating | |
| | | 25 wt % | | 25 wt % |
| Solvent | water | acetone/water | water | acetone/water |
| No cross- | 155 ± 0.8 | 56.4 ± 0.1 | flocculation | 122 ± 1 |
| linker | 1.3 ± 1.0% | 4.7 ± 0.7% | | 10.2 ± 0.6% |
| 1 mol. % | 158 ± 2.5 | 54.6 ± 0.5 | 175 ± 0.4 | 220 ± 1.8 |
| MBA | 0.9 ± 0.2% | 4.4 ± 0.7% | 2.2 ± 1.2% | 0.9 ± 0.3% |

TABLE 2
Comparison of nanoparticle diameter and swelling ratio for cross-linked
nanoparticles prepared with 0.125 M MMA, 9.25 mM KPS in 25 wt %
acetone/water solution and the cross-linker used is either 1 mol % or 3 mol %.
Reaction conditions: 70° C., microwave power 28 ± 2 W, 1 hour.

| | Diameter (nm) and polydispersity | | | | | |
|---|---|---|---|---|---|---|
| | EGDM | | EGDA | | MBA | |
| | 1 mol % | 3 mol % | 1 mol % | 3 mol % | 1 mol % | 3 mol % |
| Water | 113 ± 1.6 | 231 ± 3.3 | 54 ± 0.5 | 99 ± 0.7 | 55 ± 0.6 | 60 ± 0.3 |
| | 5.7 ± 0.4% | 4.4 ± 2.3% | 3.5 ± 0.8% | 8.3 ± 0.6% | 4.4 ± 0.7% | 7.8 ± 1.5% |
| DMF | 163 ± 1.1 | 322 ± 1.9 | 102 ± 0.2 | 144 ± 0.8 | 533 ± 76 | 135 ± 0.8 |
| | 7.9 ± 0.9% | 2.3 ± 2.7% | 11.0 ± 1.3% | 6.2 ± 1.5% | 15.9 ± 5.4% | 18.4 ± 1.2% |
| Swelling | 1.44 | 1.39 | 1.89 | 1.45 | 9.69 | 2.25 |
| ratio | | | | | | |

What is claimed is:

1. A method for microwave preparation of polymeric nanoparticles, comprising the steps:
a) producing a mixture containing:
i) a first monomer;
ii) a polymerization initiator that is activated by microwave irradiation;
ii) a cross-linker that creates intra-particle cross-links during polymerization; and
iv) a water-based solvent and
b) irradiating said mixture with microwave radiation to facilitate polymerization of the nanoparticles.

2. A method for microwave preparation of polymeric nanoparticles according to claim 1, wherein said first polymer contains one or more double bonds and polymerizes via an addition mechanism.

3. A method for microwave preparation of polymeric nanoparticles according to claim 1, wherein said first polymer comprises an acrylate.

4. A method for microwave preparation of polymeric nanoparticles according to claim 1, wherein said polymerization initiator produces a free radical upon microwave irradiation.

5. A method for microwave preparation of polymeric nanoparticles according to claim 1, wherein said polymerization initiator is water soluble and selected from a group consisting of persulfates, peroxydisulfates, azo compounds, and peroxides

6. A method for microwave preparation of polymeric nanoparticles according to claim 1, wherein said polymerization initiator comprises potassium persulfate.

7. A method for microwave preparation of polymeric nanoparticles according to claim 1, wherein said intra-particle cross-linker is selected from group consisting of ethylene glycol dimethacrylate, ethylene glycol diacrylate, and N,N′-methylenebisacrylamide.

8. A method for microwave preparation of polymeric nanoparticles according to claim 1, wherein said water-based solvent comprises an hydrophilic combination of water and an organic solvent.

9. A method for microwave preparation of polymeric nanoparticles according to claim 1, wherein said water-based solvent comprises a combination of water and acetone.

10. A method for microwave preparation of polymeric nanoparticles according to claim 1, wherein said microwave irradiation is produced via a microwave reactor with a power range limited by a maximum power of said reactor.

11. A method for microwave preparation of polymeric nanoparticles according to claim 1, further comprises heating said reaction mixture with said microwave irradiation to a temperature range of about 50° C. to about 100° C.

12. A method for microwave preparation of polymeric nanoparticles according to claim 1, wherein said mixture further comprises a second monomer that provides a free functional group after polymerization.

13. A method for microwave preparation of polymeric nanoparticles according to claim 12, wherein said second monomer is selected from a group consisting of acrylic acid, methacrylic acid, itaconic acid, 2-acrylamino-2-methyl-1-propane sulphonic acid, ethylene glycol methacrylate phosphate, N-(hydroxymethyl)acrylamide, poly(ethylene glycol) monomethacrylate, 2-hydroxyethyl methacrylate, 2-aminoethyl methacrylate, 1-vinylimidazole, sugar-based methacrylate and acrylate.

14. A method for microwave preparation of sub-50 nm size-range polymeric nanoparticles, comprising the steps:
a) producing a mixture containing:
i) a first monomer;
ii) a polymerization initiator that is activated by microwave irradiation;
ii) a cross-linker preferentially creating intra-particle cross-links over inter-particle cross-links during polymerization; and
iv) a water-based solvent and
b) irradiating said mixture with microwave radiation to facilitate polymerization of the nanoparticles.

15. A method for microwave preparation of sub-50 nm size-range polymeric nanoparticles according to claim 14, wherein said first polymer contains one or more double bonds and polymerizes via an addition mechanism.

16. A method for microwave preparation of sub-50 nm size-range polymeric nanoparticles according to claim 14, wherein said first polymer comprises an acrylate.

17. A method for microwave preparation of sub-50 nm size-range polymeric nanoparticles according to claim 14, wherein said polymerization initiator produces a free radical upon microwave irradiation.

18. A method for microwave preparation of sub-50 nm size-range polymeric nanoparticles according to claim 14, wherein said polymerization initiator is water soluble and selected from a group consisting of persulfates, peroxydisulfates, azo compounds, and peroxides.

19. A method for microwave preparation of sub-50 nm size-range polymeric nanoparticles according to claim 14, wherein said polymerization initiator comprises potassium persulfate.

20. A method for microwave preparation of sub-50 nm size-range polymeric nanoparticles according to claim 14, wherein said polymerization initiator's concentration is less than about 20 wt % of said monomer.

21. A method for microwave preparation of sub-50 nm size-range polymeric nanoparticles according to claim 14, wherein said intra-particle cross-linker is selected from group consisting of ethylene glycol dimethacrylate, ethylene glycol diacrylate, and N,N′-methylenebisacrylamide.

22. A method for microwave preparation of sub-50 nm size-range polymeric nanoparticles according to claim 14, wherein said intra-particle cross-linker's concentration is less than about 5 mol % of said monomer.

23. A method for microwave preparation of sub-50 nm size-range polymeric nanoparticles according to claim 14, wherein said water-based solvent comprises an hydrophilic combination of water and an organic solvent.

24. A method for microwave preparation of sub-50 nm size-range polymeric nanoparticles according to claim 14, wherein said water-based solvent comprises a combination of water and acetone.

25. A method for microwave preparation of sub-50 nm size-range polymeric nanoparticles according to claim 14, wherein said microwave irradiation is produced via a microwave reactor with a power range limited by a maximum power of said reactor.

26. A method for microwave preparation of sub-50 nm size-range polymeric nanoparticles according to claim 14, further comprises heating said reaction mixture with said microwave irradiation to a temperature range of about 50° C. to about 100° C.

27. A method for microwave preparation of sub-50 nm size-range polymeric nanoparticles according to claim 14, wherein said mixture further comprises a second monomer that provides a free functional group after polymerization.

28. A method for microwave preparation of sub-50 nm size-range polymeric nanoparticles according to claim 27, wherein said second monomer is selected from a group consisting of acrylic acid, methacrylic acid, itaconic acid, 2-acrylamino-2-methyl-1-propane sulphonic acid, ethylene glycol methacrylate phosphate, N-(hydroxymethyl)acrylamide, poly(ethylene glycol) monomethacrylate, 2-hydroxyethyl methacrylate, 2-aminoethyl methacrylate, 1-vinylimidazole, sugar-based methacrylate and acrylate.

29. A method for microwave preparation of sub-50 nm size-range polymeric nanoparticles according to claim 27, wherein said second monomer's concentration range is about >0 mol % to about 20 mol % of total monomer concentration.

30. A method for microwave preparation of sub-50 nm size-range polymeric nanoparticles, comprising the steps:
a) producing a mixture containing:
i) an acrylate first monomer;
ii) a polymerization initiator that is activated by microwave irradiation, wherein said polymerization initiator is water soluble and selected from a group consisting of persulfates, peroxydisulfates, azo compounds, and peroxides;
ii) a cross-linker preferentially creating intra-particle cross-links over inter-particle cross-links during polymerization, wherein said intra-particle cross-linker is selected from group consisting of ethylene glycol dimethacrylate, ethylene glycol diacrylate, and N,N′-methylenebisacrylamide; and
iv) a water-based solvent and
b) irradiating said mixture with microwave radiation to facilitate polymerization of the nanoparticles.

31. A method for microwave preparation of sub-50 nm size-range polymeric nanoparticles according to claim 30, wherein said polymerization initiator comprises potassium persulfate.

32. A method for microwave preparation of sub-50 nm size-range polymeric nanoparticles according to claim 31, wherein said polymerization initiator's concentration is less than about 20 wt % of said monomer.

33. A method for microwave preparation of sub-50 nm size-range polymeric nanoparticles according to claim 30, wherein said intra-particle cross-linker's concentration is less than about 5 mol % of said monomer.

34. A method for microwave preparation of sub-50 nm size-range polymeric nanoparticles according to claim 30, wherein said water-based solvent comprises an hydrophilic combination of water and an organic solvent.

35. A method for microwave preparation of sub-50 nm size-range polymeric nanoparticles according to claim 30, wherein said water-based solvent comprises a combination of water and acetone.

36. A method for microwave preparation of sub-50 nm size-range polymeric nanoparticles according to claim 30, wherein said microwave irradiation is produced via a microwave reactor with a power range limited by a maximum power of said reactor.

37. A method for microwave preparation of sub-50 nm size-range polymeric nanoparticles according to claim 30, further comprises heating said reaction mixture with said microwave irradiation to a temperature range of about 50° C. to about 100° C.

38. A method for microwave preparation of sub-50 nm size-range polymeric nanoparticles according to claim 30, wherein said mixture further comprises a second monomer that provides a free functional group after polymerization.

39. A method for microwave preparation of sub-50 nm size-range polymeric nanoparticles according to claim 38, wherein said second monomer is selected from a group consisting of acrylic acid, methacrylic acid, itaconic acid, 2-acrylamino-2-methyl-1-propane sulphonic acid, ethylene glycol methacrylate phosphate, N-(hydroxymethyl)acrylamide, poly(ethylene glycol) monomethacrylate, 2-hydroxyethyl methacrylate, 2-aminoethyl methacrylate, 1-vinylimidazole, sugar-based methacrylate and acrylate.

40. A method for microwave preparation of sub-50 nm size-range polymeric nanoparticles according to claim 38, wherein said second monomer's concentration range is about >0 mol % to about 20 mol % of total monomer concentration.

41. Sub-50 nm range size polymeric nanoparticles produced by a microwave process comprising: comprising the steps:
a) producing a mixture containing:
i) a first monomer;
ii) a polymerization initiator that is activated by microwave irradiation;
ii) a cross-linker that creates intra-particle cross-links during polymerization; and
iv) a water-based solvent and
b) irradiating said mixture with microwave radiation to facilitate polymerization of the nanoparticles.

42. A method for microwave preparation of polymeric nanoparticles according to claim 41, wherein said first polymer contains one or more double bonds and polymerizes via an addition mechanism.

43. A method for microwave preparation of polymeric nanoparticles according to claim 41, wherein said first polymer comprises an acrylate.

44. A method for microwave preparation of polymeric nanoparticles according to claim 41, wherein said polymerization initiator produces a free radical upon microwave irradiation.

45. A method for microwave preparation of polymeric nanoparticles according to claim 41, wherein said polymerization initiator is water soluble and selected from a group consisting of persulfates, peroxydisulfates, azo compounds, and peroxides

46. A method for microwave preparation of polymeric nanoparticles according to claim 41, wherein said polymerization initiator comprises potassium persulfate.

47. A method for microwave preparation of polymeric nanoparticles according to claim 41, wherein said intra-particle cross-linker is selected from group consisting of ethylene glycol dimethacrylate, ethylene glycol diacrylate, and N,N′-methylenebisacrylamide.

48. A method for microwave preparation of polymeric nanoparticles according to claim 41, wherein said water-based solvent comprises an hydrophilic combination of water and an organic solvent.

49. A method for microwave preparation of polymeric nanoparticles according to claim 41, wherein said water-based solvent comprises a combination of water and acetone.

50. A method for microwave preparation of polymeric nanoparticles according to claim 41, wherein said microwave irradiation is produced via a microwave reactor with a power range limited by a maximum power of said reactor.

51. A method for microwave preparation of polymeric nanoparticles according to claim 41, further comprises heating said reaction mixture with said microwave irradiation to a temperature range of about 50° C. to about 100° C.

52. A method for microwave preparation of polymeric nanoparticles according to claim 41, wherein said mixture further comprises a second monomer that provides a free functional group after polymerization.

53. A method for microwave preparation of polymeric nanoparticles according to claim 52, wherein said second monomer is selected from a group consisting of acrylic acid, methacrylic acid, itaconic acid, 2-acrylamino-2-methyl-1-propane sulphonic acid, ethylene glycol methacrylate phosphate, N-(hydroxymethyl)acrylamide, poly(ethylene glycol) monomethacrylate, 2-hydroxyethyl methacrylate, 2-aminoethyl methacrylate, 1-vinylimidazole, sugar-based methacrylate and acrylate.
